(19) United States
(12) Patent Application Publication
(10) Pub. No.: US 2011/0148581 A1
(43) Pub. Date: Jun. 23, 2011

(54) System for asset tracking

(75) Inventors: Ahmad Chamseddine, Calgary (CA); Richard Clayton Shervey, Penticton (CA)

(73) Assignee: PSST Mobile Equipment Ltd.

(21) Appl. No.: 12/654,540

(22) Filed: Dec. 22, 2009

(51) Int. Cl. H04Q 5/22

(52) U.S. Cl. 340/10.1

(57) ABSTRACT

An asset tracking system includes one or more RFID readers and one or more RFID tags cooperating with the readers, and at least one garment, wherein the readers each include an RF wideband transceiver and a linearly polarized antenna. Each reader polls periodically a corresponding one or more RFID tag to determine a distance of a particular tag from each reader. Each reader computes the tag's distance in real-time and updates a corresponding database in real-time for an on-demand reaction as determined by a processor in each reader. Each tag includes a wideband transceiver and an antenna array. The antenna array is implanted on each garment and ensures a spherical coverage around each tag. The antenna array includes two or more patch antenna distributed around each garment so as to provide full 360 degree and spherical coverage around each garment, and wherein each patch antenna is provided on a dielectric. Coverage is thereby provided by the patch antenna array and removes the need of having a single line of sight. Each tag may include an on-board processor adapted to adaptively switch between the antennas in the antenna array so as to select an appropriate antenna of the array for a signal from a corresponding reader.

### CROSS REFERENCE TO RELATED APPLICATION

This application claims priority from U.S. Provisional Patent Application No. 61/193,730 filed Dec. 19, 2008 entitled System for Asset Tracking.

### FIELD OF THE INVENTION

This invention relates to the field of radio frequency identification systems and in particular to a system for asset tracking using radio frequency identification and improved antenna adapted for use in safety systems.

### BACKGROUND OF THE INVENTION

The system for asset tracking according to the present invention, including the improved antenna forming a part thereof, aims for example to assist in improving workers' safety in hazardous workplaces, when incorporated as part of for example a radio frequency identification (RFID) based personal safety system (PSS) such as described in U.S. patent application Ser. No. 11/822,911 and published under publication number US02008-0018472-A1 on Jan. 24, 2008, which provides one example of how aspects of the present invention may be employed. The PSS, in summary, prevents an accident from happening between a worker and a mobile machine such as a forklift. In a typical workplace, there are a number of forklifts that circulate in close proximity to a group of workers, naturally increasing the chances for an accident to happen. The PSS is intended to improve the workers' safety in all-time and real-time radio-frequency (RF) wireless ranging system without any intervention from the worker or the machine operator by providing an independent monitoring wireless sensor that logs the distance between the forklift and the worker, and then controls the machine for example slows down or stops the machine when this distance becomes less then a pre-defined danger zone. Machine operator and worker warnings are incorporated into the machine and the workers vest or harness. The PSS is intended to include indoor usage, where the use of a conventional narrowband technique is excluded because of it vulnerability to the multipath and fading signals, and unsuitable due to low accuracy in short distance ranging applications. In contra-distinction spread spectrum systems use techniques that are specifically suitable for communication in severe multipath environments. The distance measurement accuracy in such systems is highly improved due to the wideband nature of the signal. The Chirp Modulation Spread Spectrum (CSS) is one kind of these techniques and presents further advantages when it comes to short distance ranging, such as removing of the “near-far” problem faced in short distance ranging with other systems.

The PSS uses directional antennas directionally detecting RFID tags within the danger zones around the machine, and, cooperating with the tags worn by the workmen, antennas cooperating with the tags worn by the workmen, antennas cooperating with the tags where the antennas are distributed about the article worn by the workmen so as to surround the workmen. Where the article worn by the workman is a safety vest, the safety vests may include shoulder antenna and side antenna which each wrap around the vest so as to be exposed to both the front and back of the vest.

### SUMMARY OF THE INVENTION

In summary, the asset tracking system according to the present invention includes one or more RFID readers and one or more RFID tags cooperating with the readers, and at least one garment, wherein the readers each include an RF wideband transceiver and a linearly polarized antenna. Each reader polls periodically a corresponding one or more RFID tag to determine a distance of a particular tag from each reader. Each reader computes the tag's distance in real-time and updates a corresponding database in real-time for an on-demand reaction as determined by a processor in each reader. Each tag includes a wideband transceiver and an antenna array. The antenna array is implanted on each garment and ensures a spherical coverage around each tag. The antenna array includes two or more patch antenna distributed around each garment so as to provide full 360 degree and spherical coverage around each garment, and wherein each patch antenna is provided on a dielectric. Coverage is thereby provided by the patch antenna array and removes the need of having a single line of sight. Each tag may include an on-board processor adapted to adaptively switch between the antennas in the antenna array so as to select an appropriate antenna of the array for a signal from a corresponding reader.

Each patch antenna may be a linearly-polarized antenna with a high cross-polar component so as to receive signals with random polarization, whereby the reader's linearly-polarized signals are received without losing 3 dB of signal power that otherwise would be lost with a circularly polarized patch.

The readers may be a single reader adapted to track one or more of tags without the position of the single reader being known. The reader may be mounted on either a mobile or stationary platform. Where two or more readers are at known physical positions with respect to each other, the tags may be tracked and their coordinates determined.

### BRIEF DESCRIPTION OF THE DRAWINGS

FIG. 1 is, in plan view, a diagrammatic illustration of the reaction and warning zones for forward and backward covering directional antennas mounted on a piece of mobile machinery, and the superposition of the coverage of a monopole antenna also mounted on the mobile machine.

FIG. 2 is a front view of a safety vest according to one embodiment of the present invention.

FIG. 3a is a plan view of an enlargement of one of the patch antenna of FIG. 2.

FIG. 3b is an exploded view of the patch antenna of FIG. 3a.

FIG. 4a is a test worker standing during base line reading using dual front and rear patch antennas on the workers vest.

FIG. 4b is the test worker of FIG. 4a facing the reader and stooping to pick up a box during detection testing.

FIG. 4c is the test worker of FIG. 4b right side onto the reader during testing to detect the worker.

FIG. 4d is the test worker of FIG. 4c lying down, with right side on the reader during detection testing.

FIG. 4e is the test worker of FIG. 4d stooping to pick up a box while facing away from the reader during detection testing.

FIG. 4f is the test worker of FIG. 4e holding a tin-foil covered box in front of his vest so as to cover the front patch antenna.

FIG. 5 is a magnitude versus radial degrees plot of the dual-antenna arrangement, co-polar, when measured in the horizontal H-plane and the dual-antenna is worn by a test worker.

FIG. 6 is a diagrammatic view of an RFID transponder tag and the corresponding RFID transponder detection system.

FIGS. 7a and 7b are, respectively, diagrammatic representations of a multiple sensor network, and a multiple sensor network mounted, in plan view, on a vehicle.

FIG. 8 is in plan view wheel loader bucket type, depicting a full coverage zone.

FIG. 9 is, in perspective view, a mobile machine having an appendage moving in proximity to a worker.

### DETAILED DESCRIPTION OF EMBODIMENTS OF THE INVENTION

In the PSS example, the worker's RF sensor includes the antenna connected to a transceiver and a processor that communicates with the machine-mounted sensor via the transceiver and antenna. The machine mounted sensor monitors the paths that the machine, for example a forklift would take in the forward and backward directions, and therefore includes two directional antennas, namely a forward-looking and a rearward looking antenna. Only one of these antennas is activated at a time depending on the direction of movement. Each of the workers' sensors is given a unique identification (ID), so that the system is a full RFID wireless system. Moreover, many sensors with another set of IDs may be mounted on objects like walls or posts so that the machine may be programmed to react differently according to the set of IDs detected. Some machine types only require a single monopole antennae as per FIG. 18.

The PSS described by way of example herein inhibits accidents from happening if workers are located in the front or the rear of a forklift. However, the sides of the forklift are not covered, as the front and rear directive antennas can not see the sides due to their high gain. Protecting the sides of a forklift could be advantageous, for example in the instance of another forklift driving towards the unprotected sides of the first forklift, or if a workman is present at the side of the first forklift and appears to be in a potential danger. There are different ways to cover the forklift sides. Installing another directional antenna on each side is one of the options. This technique requires the use of two extra RFID sensors and their antennas. This increases the total cost of the safety system.

Another solution includes using one monopole antenna connected to a RF sensor that monitors the sides. The monopole's donut-shaped radiation pattern allows for coverage of both sides of the forklift, in addition to the front and the rear. The monopole coverage zone need not be larger than 10% of the directional ones.

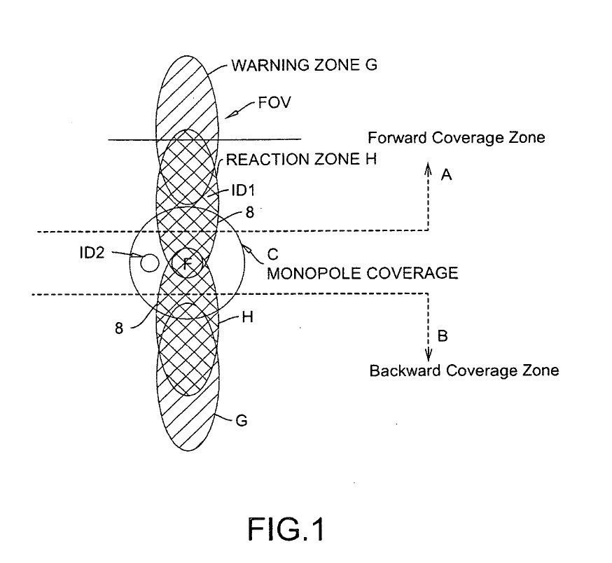

This further embodiment of the PSS will thus include two directional antennas 8 for the forward and backward directions, A and B respectively in FIG. 1, and one monopole antenna providing monopole coverage C for primarily monitoring the sides of the forklift F, as illustrated diagrammatically in FIG. 1. The directional antennas may be connected either to two different RF sensors or to a single sensor by a single-pole double-throw (SPDT) switch. The direction of movement of the forklift selects which sensor is ON in the first case (using 2 sensors) or controls the switch through-way in the second case (using a SDPT).

When available, if the monopole's and directional antennae sensors use different radio channels, then they may be used simultaneously without interfering with each other. However, if they share the same communication channel, they would employ a switching mode to avoid jamming each other.

To give an example of operation such as illustrated in FIG. 1, when the directional antenna providing the warning and reaction zones G and H respectively are switched ON, a detected tag signal, for example with ID1, will be considered as a worker 24 present in that antenna's field-of-view (FOV). Next, when the monopole's radio is ON (and the other radios for zones G and H are OFF) then one the following scenarios would be possible:
1—If ID1 is detected, then the worker 24 (ID1 holder) is located in the front (or rear) of the forklift. The forklift was made aware of this presence during the directional antenna ON step in the preceding cycle.
2—If ID2 is detected, then this ID holder must be located at one of the forklift sides as ID2 was not detected in zones G or H during the directional antenna ON step in the preceding cycle. The machine operator is then notified accordingly.
3—If no ID is detected by the monopole antenna, then no one is present near the sides, and the ID1 located by the directional antennas is located at a further distance from the front (or the rear) than the distance covered by the coverage zone, for example partially that of zone H, of the monopole antenna. However, the directional antenna may still keep tracking the position of ID1.

The monopole radio may use different types of modulation at different frequency bands other than the directional antennae's. Using a narrowband signal could be sufficient and hence the switching mode would not be required.

The data available at the machine-mounted sensor may be forwarded to a logging gateway or central computer through a Wi-Fi connection. This adds another dimension to the system. For instance, a designated supervisor can monitor any deficiency in the machines sensors or even send instructions to those sensors without interruption to the work pace.

In one embodiment of the Personnel Safety System, interrogators (for example a reader) are installed on mobile machines and tags are worn by workers 24 (or visitors) who are going to be in proximity to the mobile machines for example forklift F. System reliability is important, so the communication between a reader and a tag must be established without fail every time the worker (tag) comes close to the machine (reader). To do so the antennas on the tag and the reader must be configured in such a way that a line of sight (LOS) is always guaranteed between them. A monopole, or any other antenna with an omnidirectional radiation pattern, mounted on the worker's hard hat would be one. This may work for some applications. However, in actual workplaces workers stack the hats on top of each other or treat them very roughly, and the possibility of damage to the antenna and electronics which are built into the hat is very high.

A safety vest 12 is another part of the safety equipment that workers are typically required to wear at their workplace. The vest typically presents a large profile or area where electronics and an antenna may be embedded. Using a monopole-like antenna embedded in the safety vest is not practical because the worker's body adversely affects the performance of the antenna in two ways. First, the worker's body will profoundly change the antenna radiation pattern, leading to “dead spots” and more frequent non-line-of-sight situations. Second, antenna mismatching and radiation absorption by the body will strongly decrease the antenna radiation efficiency. Furthermore, exposing the body to excessive radiowave radiation is not acceptable by safety guidelines for wireless design, and useless dissipation of power sharply reduces the life of the system battery.

Therefore, the antenna system 10 proposed according to the present invention includes a shielding layer that prevents the body of worker 24, when wearing vest 12, from affecting the performance of antenna mounted on or in the vest. Microstrip patch antennas with ground plane are well-suited for such applications. In an embodiment operatively at 2.4 GHz, the maximum size of a single antenna is not large enough to wrap it around the typical vest and thus two or more antennas may be necessary to cover the whole circumference of the body. Covering the entire circumference is important so that the vest may be detected by the machine reader no matter which way the worker is oriented or turned relative to the machine.

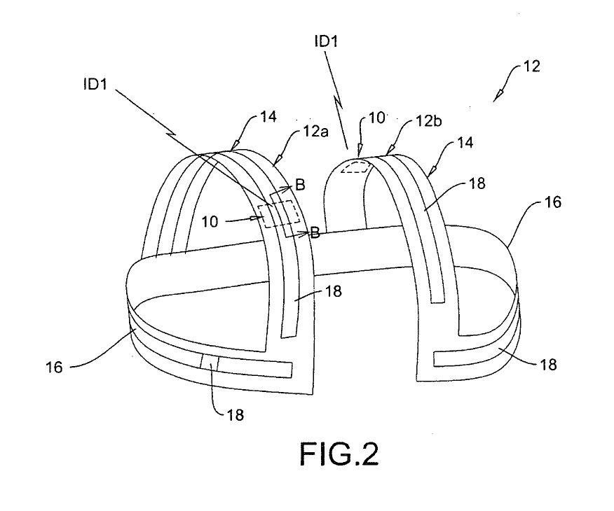

Space diversity techniques are used, with two microstrip antennas 10a integrated into the safety vest 12, shown simplified as a harness in FIG. 2. The topology chosen for this application has one antenna system 10 in the front 12a and the other in the back 12b of the upper parts of the opposite shoulders 14 of the vest 12. Other configurations are also possible, such as placing the antenna on the sides 16 of the vest over the shoulders, or even integrating antennas under the reflective strips 18 of the vest.

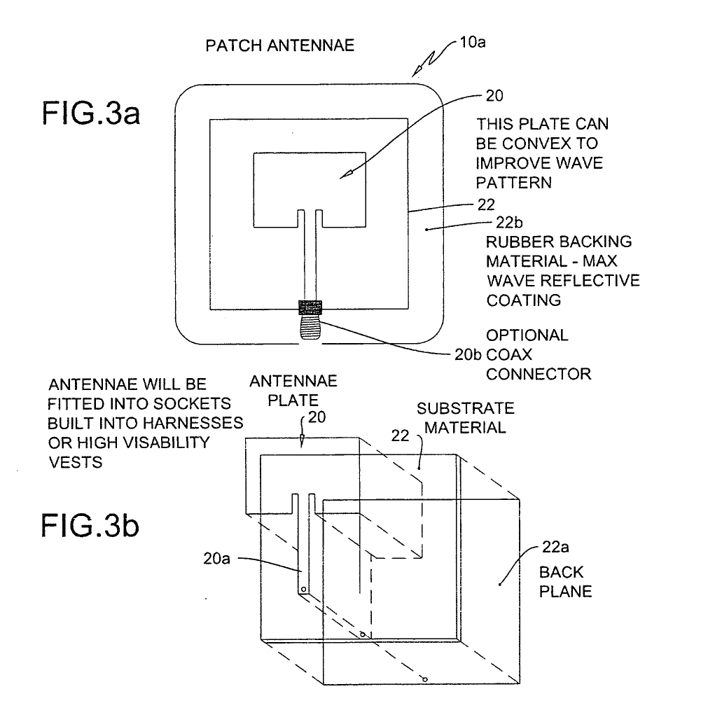

In a preferred embodiment such as seen in FIGS. 2, 3a and 3b, each antenna system 10 integrated into or onto a safety vest 12 includes a microstrip patch antenna 10a. Each patch antenna 10a includes an antennae plate 20, such as supplied by AP Circuits of Calgary, Alberta, Canada, which is mounted or built on a low cost rigid substrate 22. The use of a hard substrate 22 is mainly to eliminate any bending and warping effect that would affect the antenna performance. The total antenna size may advantageously be about 60×60 mm (2 6/16×2 6/16 inches), and is fed through an inset feed 20a. The patch antennae dimensions are optimized to cover the entire ISM frequency band 2.4-2.485 GHz. The antenna back plane 22a may be mounted on a rubber backing material 22b, which may have a reflective coating, and which may advantageously elevate the antennae from the front shoulder 12a and rear shoulder 23 of worker 24. Plate 20 may also be in one embodiment convex rather than planar, which may improve the wave pattern of the antennae. Whether elevated for improved performance due to increased LOS visibility, the antenna system 10 may be fitted into pockets built into the shoulders of the vest, wherein, again, reference to vests herein is intended to include other garments including harnesses.

The size of the patch antenna plate 20 can be further reduced if high permittivity dielectric such as ceramic is used. For example, the size may be reduced to 25×25 mm by using dielectric with dielectric constant of 12.

In one embodiment, not intended to be limiting, inset feed 20a is provided with a coax connector 20b. It may also be useful to empty so-called leaky coax which when electrically connected to the antenna and a length distributed over or around the workman's shoulders may decrease areas of reduced coverage.

The patch antenna 10a has proven to have great immunity against the human body effect. In fact, its input impedance seems to see almost no effect whether the antenna is in free space or placed anywhere against the body of for example worker 24. The matching level generated by the inset feed is good enough to keep the antenna impedance tuned regardless of how the antenna is used.

In experiments, the antenna fabricated on standard epoxy measured a gain of 3.5 dB and 3.2 dB in free space and on body, respectively, which is sufficient for this application. The E- and H-planes were measured in free space and on the body. In free space, the 3-dB beam aperture at 2.45 GHz was 76° degree and 97° degree in the E- and H-planes, respectively. When worn, the 3-dB beam aperture at 2.45 GHz became 61° degree and 127° in the E- and H-planes, respectively. These angles helped to determine the number of antennas required and the angle of orientation of the antenna on the body that provide the best coverage in the azimuthal plane and that ensure a full coverage of the worker's body boundary.

Several processing schemes may be used to transmit and receive by either of the two antennas. A selecting scheme selects the antenna that presents the highest Signal-to-Noise (SNR) ratio. A combining scheme maintains the connection on both antennas and weights the received signals to deliver the desired signal. The Switching scheme is the simplest method. It switches the front-end input between the receiving antennas and selects the received signal with a level higher than a certain threshold. An improved switching scheme was tailored for this application in which the RF front-end compares the signal level received by the two antennas and, in addition, ranges the Reader and then selects the shorter distance to filter out the reflected path. The connection between the front-end and the antennas is made by an RF switch integrated on the Tag PCB. Using more than one antenna is also possible by using a Single Pole Multiple Throw RF switch.

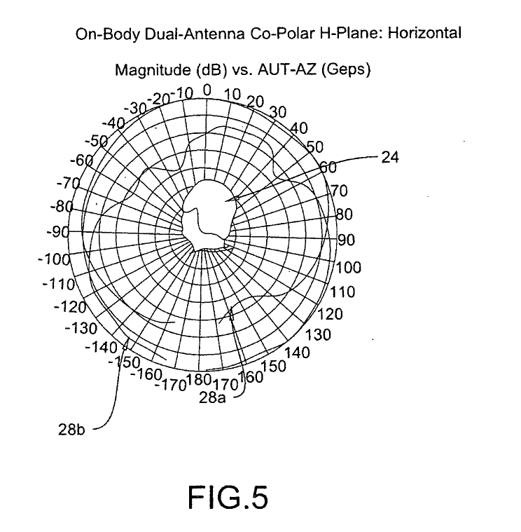

The radiation pattern of two antennas placed on the front and back, respectively, is shown in FIG. 5. The radiation pattern diagrams show that the superposition of the front and back antennas' radiation patterns overlap quite nicely to cover the full 360 degrees circumference around the body. The mild dip of about 5 dB at the 90° elevation is expected due to the nature of the flat antenna radiation, and also some masking by the shoulders of the person wearing the vest.

In fact, the radiation patterns 28a and 28b in FIG. 5 of respectively, the front and back antenna show that the front antenna assures high intensity signal on the low elevation fore left side and high intensity signal on the low elevation back right side for the back antenna. However the signal gets weaker on the frontal right hand side for the front antenna and the rear left side for the back antenna. Therefore, one possible way to improve the side coverage can be achieved by adding a second antenna on each side of the shoulders, that is front left, front right, rear left and rear right antenna, to have a full and uniform coverage. This could work well; it would increase, however, the switching time between the antenna array elements.

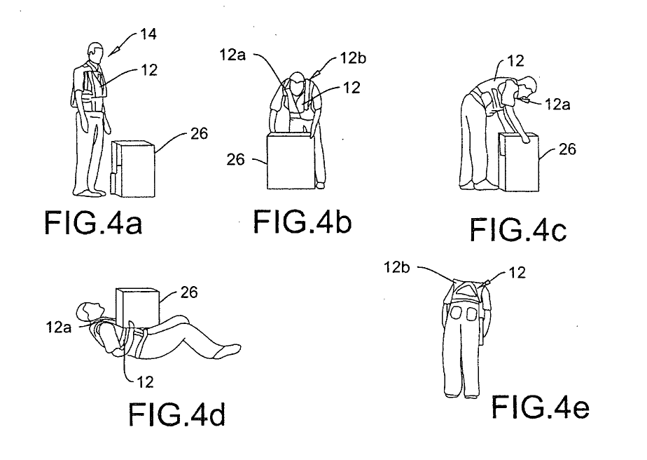

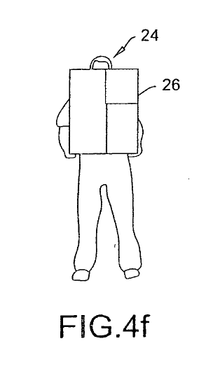

In a set of tests, detection of a worker 24 was measured when the worker was at various angles and in various postures such as seen in FIGS. 4a-4f. Again a single worker was employed with a single reader. The worker and rear separation was 17 meters. The workers tag and reader output power was minus 20 dBm. The reader had a monopole antenna. The workers vest had front and rear patch antennas on opposite shoulders. FIG. 4a depicts the worker in the baseline pose. FIG. 4b depicts the worker bending to pick up the box while standing side-on to the reader. FIG. 4d depicts the worker lying or prone simulating the worker performing work while lying down or sleeping. FIG. 4e depicts the worker lifting the box while facing away from the RFID reader. FIG. 4f depicts the worker holding the box in front of the vest shoulder mounted antenna. The box, as tested, was covered with tin foil.

In the testing where the worker was in the stance of FIG. 4b, the front antenna on the vest 12 was detected and the rear antenna 20 gave reflected path data. In the stance of FIG. 4c, the front antenna, that is on the shoulder 14 of the vest closest to the RFID reader, was detected. In the stance of FIG. 4d, the front antenna of the workers vest was detected. In the stance of FIG. 4e, the rear antenna of the workers vest was detected and the front antenna gave reflected data. In the stance of FIG. 4f visual evaluation of the data showed no significant problems. In this set of tests the worker was detected in all stance positions. Reflected path measurements were present. At least one sensor reported correct ranging distance in all instances. The error rates were similar to the baseline testing although the broadcast miss-rate was slightly higher than that of the baseline testing.

The conclusions were thus drawn that the carrying of box 26 in front of a workers antenna 20 on the workers vest 12 had little effect on detection of the worker by the RFID reader and that the various box carrying and lifting scenarios showed substantially no difference based on the box positions. It was further concluded that the dual antenna provided full 360 degrees of coverage for the worker wearing the vest, not withstanding that results from individual rotation tests suggested a 5 degree angle on each side where measurements may not have been reliable. Thus the dual antenna was an improvement and not merely the sum of the individual antennas as the dual antenna provided very good results during the 360 degree turn tests in the 5 degree angle positions where measurements were not as reliable when testing the individual antennas. It was determined that current antenna linear vertical polarization was sufficient to provide detection when the test worker was bent over.

It should be noted that a fully integrated solution is possible by using fabric antennas directly sewn on the safety fabric. A simple fabric antenna can be made of a sheet of conductive fabric laid on an unwoven fabric material such as fleece or polyester. This will remove the need to use coaxial cables to connect the PCB to antennas 20 mounted for example by epoxy on rigid substrates 22

In the preferred embodiment antennae, plate 20 is planar. The top layer 20a of the patch Antenna plate 20 may be mounted onto an etched upper surface on planar dielectric substrate 22. This kind of antenna radiates with a quite a uniform field intensity in the upper hemisphere. Typical the radiation pattern of a patch antenna shows strong radiation intensity in the boresight direction, and then slow decrease of the intensity as the observer or RFID reader is off the boresight. This is expected for this non high directional antenna. At elevations close to 90 degrees from the boresight, the signal intensity is about 10 dB below the peak signal. This may lead to losing signal tracking when the patch antenna is ranged from the side of the shoulders. Using two or more antennas proved to improve signal coverage without losing signal tracking. However, it has been noticed that, it would be advantageous to slightly redesign the antennae to allow a larger side lobe that would extend past the wearers shoulder creating a more uniform wave pattern around the worker. This would allow lower overall system power levels increasing battery life on the vests.

Human body style is a contributing factor for spherical wave pattern coverage around the worker. Antennae alignment and proper fit of the garment are both important considerations and perhaps as many as six different varieties or sizes of vest will be needed to ensure proper fit. For example on a barrel chested worker the antennae will not be aligned properly on a vertical plane and so the addition of a shaped piece of material (perhaps rubber) under the antennae will work to properly align the antennae within the vest. Every worker will have to be test fit for their vest or harness to ensure adequate coverage.

These dips in wave pattern coverage only come into play at the lower power levels and with an ill fitting vest slightly higher base power level would have to be employed.

The current patch antenna may be made more sensitive to receive any reflected wave by making it a circularly polarized patch. This may further increase the patch antenna gain for the non-collinear signals, and hence making the patch more susceptible to signals from the Reader's linearly polarized antenna received with any random orientation.

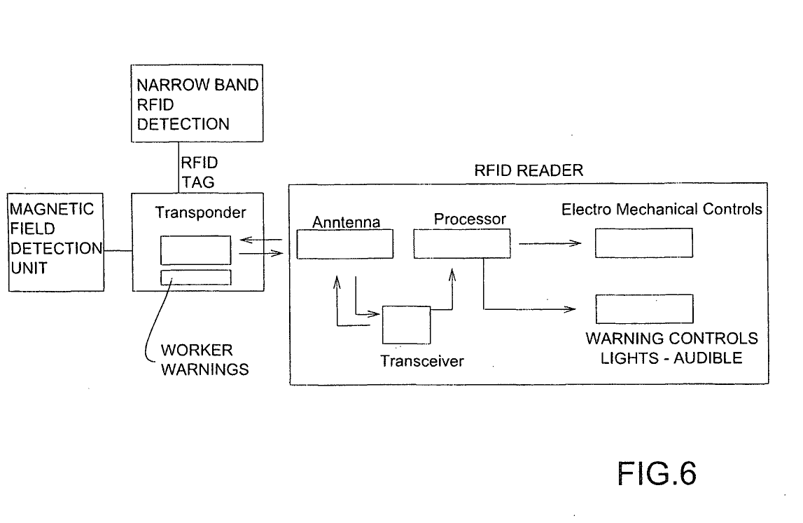

An RFID system such as shown by way of example in FIG. 6 incorporating a garment having a transponder (and corresponding antenna mounted and arranged according to the present invention) offers the unique feature of being able to accurately range an object, or person, or a machine equipped with the same RFID system, from any angle by the RFID reader. The ranging accuracy may be as accurate as 0.5 meters indoors or outdoors regardless of the multipath level. This unique combination of ranging by the RFID reader and garment (such as vest 12) coverage makes this system very competitive to track using an RFID reader and locate any assets such as those wearing a RFID tag or a garment in any environment without worrying about keeping a single line of sight between the RFID reader and the asset.

At slow speed we use a very lower power level to keep the machine's wave pattern spread to a minimum. As the machine speeds up the system automatically shifts to our operating power level (we don't keep increasing the power levels). But for a very long range detection over 100 meters the power levels may be amplified depending upon the work environment.

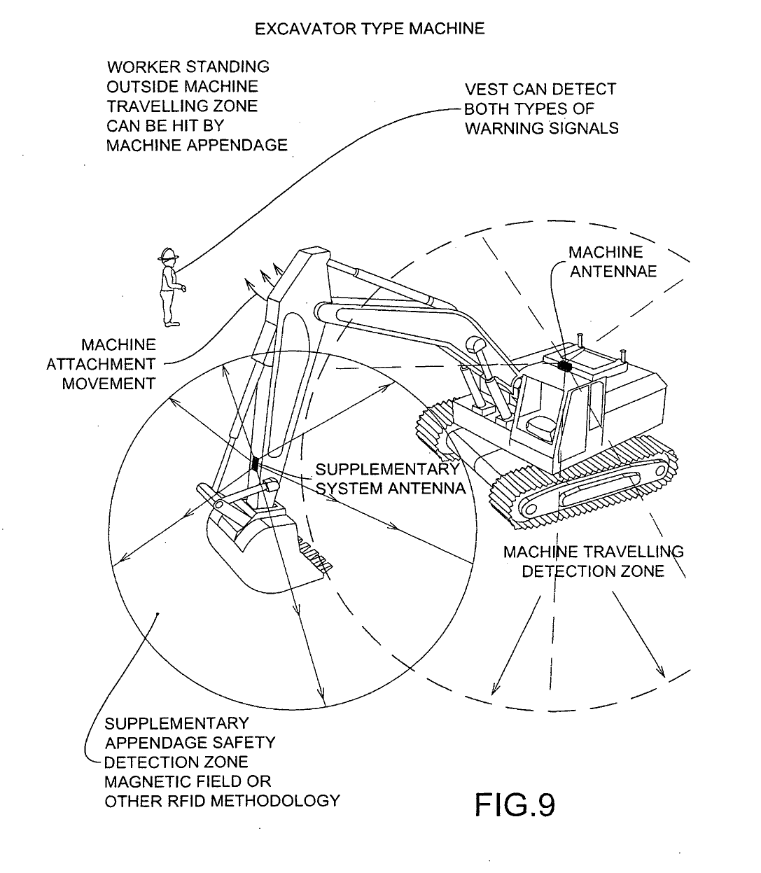

In one embodiment of the present invention, the power level is automatically adjusted with the speed of the mobile machine. The faster the machine is moving, the higher the power level. This leads to the problem, however that the most dangerous scenario for a worker is when the mobile machine is close to the worker and moving slowly, which may be counter-intuitive to what would be expected. That is, it may conventionally be assumed that a mobile machine would be most dangerous while moving quickly. In the instance of a piece of mobile equipment that has a moving appendage or tool it may be desirable to have two different non-interfering detection systems, for example an excavator such as the one in FIG. 9 has the ability to swing the digging boom in one direction while the whole machine moves in a different direction. In a case like this both of the sensing systems would send inputs to the main processor and would not cancel out each others signals.

System design can incorporate totally enclosed combined antennae/processor units—each one capable of individual operation or they can interact with one another for use where triangulation is desirable for example on large equipment such as haul trucks or earth moving equipment.

By using complete units the system can have real-time asset location and tracking and if coupled with a central processor the system accuracy and distance locating is speeded up considerably. (Wireless communication or hard wired).

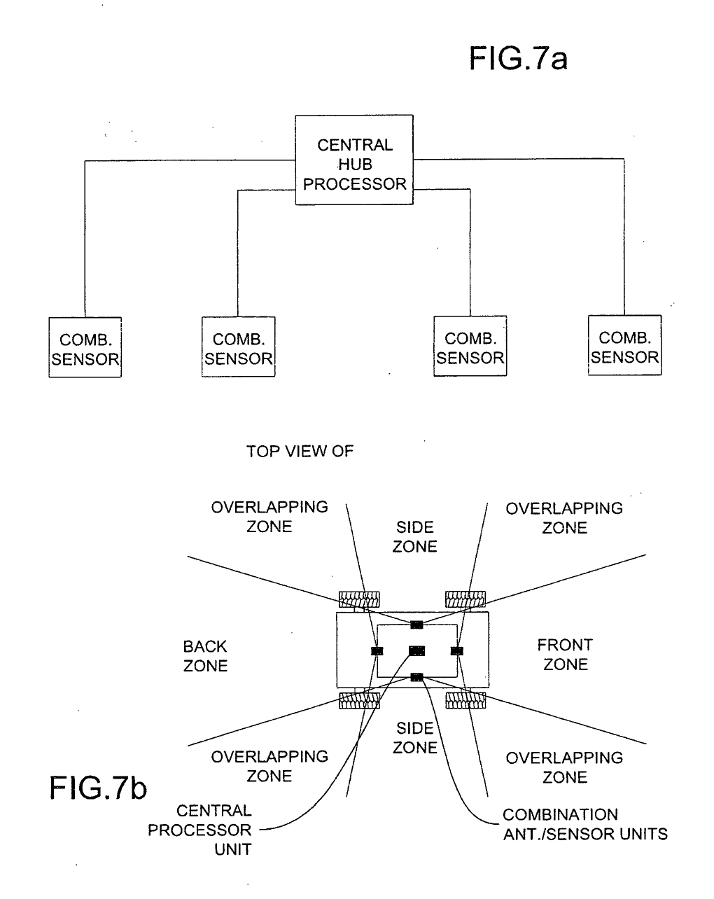

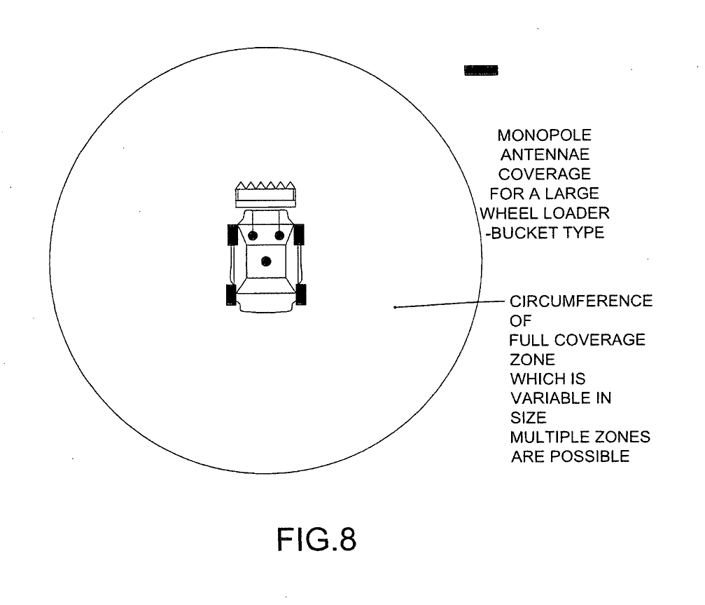

With this application of the present invention and as diagrammatically illustrated in FIGS. 7a and 7b, we can determine which one of eight or more zones an asset is in and in the way an appropriate response to the situation can be determined.

The vest is an integral part of the whole system that can be tailored to suit any jobsite requirements. Some machines such as skidsteer loaders only need a small reaction zone and possibly no warning zone—depending entirely upon the jobsite situation. Our customers and regulatory bodies for workplace safety can decide the exact requirements and our system can be programmed to meet those requirements. The system can be a basic-worker detection/warning apparatus, or be integrated into the mobile equipment control system in order to automatically activate certain pre-programmed responses.

Until anti-lock braking systems become standard on mobile equipment, this safety system will not reach it's full potential. Right now it is possible to slow these machines by adjusting engine RPM and or throttle settings, but bringing a machine to a safe stop automatically would likely require anti-lock braking technology.

In situations where, instead of the machine being mobile, the machine is stationary and the worker is the only mobile player in the scenario; in such circumstances, instead of or in conjunction with, the system of RFID tracking and the use of the antennae described herein may be supplemented by a magnetic-field-based warning zone detection system for example using magnetic field sensor's according to the RuBee IEEE standard. In the prior art applicant is aware of U.S. Pat. No. 5,939,986, which issued on Aug. 17, 1999 to Schiffbauer et al.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An asset tracking system comprising:
one or more RFID readers and one or more RFID tags cooperating with said readers, and at least one garment,
wherein said readers each include an RF wideband transceiver and a linearly polarized antenna,
and wherein said each reader polls periodically a corresponding said one or more RFID tag to determine a distance of a particular tag of said one or more RFID tags from said each reader,
and wherein said each reader computes said tag's said distance in real-time and updates a corresponding database in real-time for an on-demand reaction as determined by a processor in said each reader,
and wherein said each tag includes a wideband transceiver and an antenna array, and wherein said antenna array is implanted on each garment of said at least one garment and ensures a spherical coverage around said each tag,
and wherein said antenna array includes two or more patch antenna distributed around said each garment so as to provide full 360 degree and spherical coverage around said each garment, and wherein each patch antenna of said two or more patch antenna is provided on a dielectric,
whereby said coverage provided by said two or more patch antenna array removes the need of having a single line of sight.

2. The system of claim 1 further comprising an on-board processor on said each tag adapted to adaptively switch between said antennas in said antennas in said antenna array so as to select an appropriate antenna of said array for a signal from a corresponding said reader.

3. The system of claim 1 wherein said each patch antenna is a linearly-polarized antenna with a high cross-polar component so as to receive signals with random polarization, whereby said reader's linearly-polarized signals are received without losing 3 dB of signal power that otherwise would be lost with a circularly polarized patch.

4. The system of claim 1 wherein said readers are a single said reader adapted to track one or more of said tags without the position of said single reader being known.

5. The system of claim 4 wherein said reader is mounted on a mobile platform.

6. The system of claim 4 wherein two or more said readers are at known physical positions with respect to each other, whereby said tags are tracked and their coordinates determined.

7. The system of claim 4 wherein said reader is mounted on a stationary platform.

8. The system of claim 1 wherein said garment includes at least one elevating base elevating at one of said patch antenna relative to an extension of said garment.

9. The system of claim 8 wherein said at least one elevating base is mounted under said dielective for said patch antenna.

10. The system of claim 9 wherein said at least one elevating base is a pad.

11. The system of claim 10 wherein said pad is resilient.

12. The system of claim 10 wherein said pad is reflective.
